(19) United States
(12) Patent Application Publication
(10) Pub. No.: US 2022/0251848 A1
(43) Pub. Date: Aug. 11, 2022

(54) ADJUSTABLE PET STAIR RAMP

(71) Applicant: Radio Systems Corporation, Knoxville, TN (US)

(72) Inventors: Amanda Sweetnam, Knoxville, TN (US); Olivia Crum, Knoxville, TN (US); Jamy Pan, Shenzhen (CN)

(21) Appl. No.: 17/174,015

(22) Filed: Feb. 11, 2021

(51) Int. Cl. E04F 11/06; A01K 29/00; E04F 11/00; E04F 11/09

(52) U.S. Cl. CPC E04F 11/062; A01K 29/00; E04F 2011/007; E04F 11/09; E04F 2011/005; E04F 11/002

(57) ABSTRACT

An adjustable stair ramp includes a pair of risers, a series of treads, and an adjustable support leg. Cross members extend between the two risers. Each cross member has a pivotal brace with a top edge. The adjustable support leg has a main leg portion pivotally coupled to the risers. The main leg portion has an upper portion and a lower portion pivotally coupled to the upper portion. Each tread has bottom surface with a first receiving groove and a second receiving groove configured to receive the top edge of the respective brace. Each tread is pivotally coupled to the risers for pivotal movement between a high step position, a low step position, and a ramp position. The stair ramp is reconfigurable for use as a high stair, a low stair, a high ramp, and a low ramp through the positioning of the support leg and the treads.

### CROSS REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### Field of the Invention

The disclosure set forth herein relates to the field of pet stairs and ramps.

### Technology in the Field of the Invention

Pet owners have used steps or ramps as a convenient and easy way of providing a pet access to an elevated structure, such as a person's bed. However, the typical configuration of steps and/or ramps is fixed.

Accordingly, a need exists for a pet step or ramp that may be adjustable for different pets in differing environments.

### BRIEF SUMMARY OF THE INVENTION

An adjustable pet stair ramp comprises a pair of risers and a set of treads pivotally coupled to the pair of risers. The set of treads are moveable between a first step position, a second step position, and a ramp position. The adjustable pet stair ramp also has a support leg coupled to the pair of risers. The support leg is adjustable between an extended position having a first select length and a retracted position having a second select length less than the first select length.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective view of an adjustable stair ramp, shown in a high stepped configuration.

FIG. 2 is a perspective view of the adjustable stair ramp of FIG. 1, shown in a low ramp configuration.

FIG. 3 is a side view of the adjustable stair ramp of FIG. 1, shown in a high stepped configuration with a riser removed for clarity of explanation.

FIG. 4 is a side view of the adjustable stair ramp of FIG. 1, shown in a low stepped configuration with a portion of a riser removed for clarity of explanation.

FIG. 5 is a side view of the adjustable stair ramp of FIG. 1, shown in a high ramp configuration with a portion of a riser removed for clarity of explanation.

FIG. 6 is a side view of the adjustable stair ramp of FIG. 1, shown in a low ramp configuration.

FIG. 7 is an exploded perspective view of the adjustable stair ramp of FIG. 1.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### DESCRIPTION OF SELECTED SPECIFIC EMBODIMENTS

With reference next to the drawings, there is shown an adjustable step or stair ramp 10 under an embodiment, referenced hereinafter as stairs 10. The stairs 10 include a pair of elongated, parallel legs, rails, or risers 12, a series of three steps or treads 14, and an adjustable support or leg 16. The number of treads 14 may vary depending on the desired height of the stairs 10.

The two risers 12 have a generally flat foot surface 20, an outboard or exterior surface 22, an inboard or interior surface 24, a top surface 26, a bottom surface 28, and an end or sidewall surface 30. A set of three supports or cross members 34 extend between and are mounted at their ends to the inboard surfaces 24 of the two risers 12. Each cross member 34 has a top surface 36 to which is mounted a pivot hinge 38. Each pivot hinge 38 is also mounted to a pivot plate, support, or brace 40, so that each brace 40 is pivotally coupled to a respective cross member 34. Each brace 40 has a rounded top edge 42 oppositely disposed from the hinge 38.

The adjustable support leg 16 includes a brace cross member 46 extending between and mounted to the inboard surfaces 24 of the two risers 12. A stop block 48 is pivotally coupled to the brace cross member 46 through a pair of hinges 50 for pivotal movement between a locked position and an unlocked position. The stop block 48 has a laterally extending notch 52 defining a notch bottom surface 54 and a notch sidewall surface 56.

The adjustable support leg 16 also has a main leg portion 58 pivotally coupled to and between the inboard surfaces 24 of the risers 12 through a pivot pin 60 extending into both the upper end of the main leg portion 58 and the risers 12. The main leg portion 58 is pivotal about pivot pin 60 between an extended, in-use portion and a retracted, stowed position abutting the bottom of the cross members 34. The pivotal movement of the main leg portion 58 is limited by an L-shaped stop bracket 62 coupled to the inboard surface 24 of the riser 12 so as to abut the main leg portion 58 to prevent pivotal movement of the main leg portion 58 in a direction away from the riser bottom surface 20. The main leg portion 58 has a top edge or corner 64 that is configured to be received within notch 52 of the stop block 48 when the stop block 48 is in a locked position that prevents pivotal movement of the main leg portion 58 towards the riser bottom surface 20, i.e., prevents pivotal movement of the main leg portion 58 from its extended, in-use position to its retracted, stowed position.

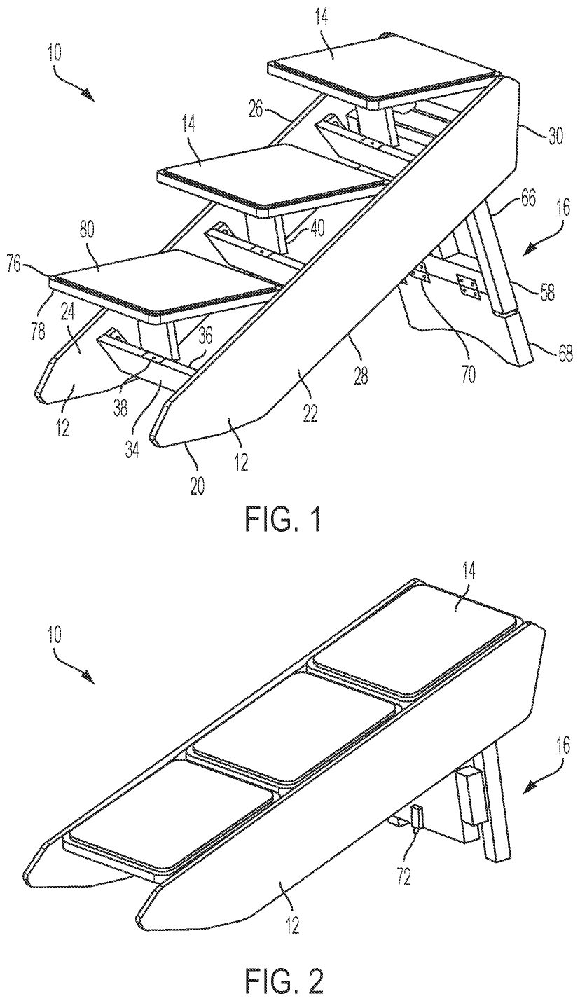

The main leg portion 58 has an upper portion 66 and a lower portion 68 pivotally coupled to the upper portion 66 through a pair of hinges 70 for 180 degree pivotal movement of the lower portion 68 relative to the upper portion 66 between an extended position, shown in FIGS. 1, 3 and 5, and a retracted position, shown in FIGS. 2, 4 and 6. A two piece latch 72 is coupled to the upper portion 66 and lower portion 68 to releasably lock the upper portion 66 and lower portion 68 together while the lower portion 68 is in the extended position.

Each tread 14 has a top surface 76 and an oppositely disposed bottom surface 78. A padded or carpeted material 80 may be coupled to the top surface 76 to provide a better gripping or traction surface for a dog utilizing the stairs 10. The tread bottom surface 78 has a laterally extending first receiving slot or groove 82 and a laterally extending second receiving slot or groove 84, each of which is configured to receive the top edge 42 of the respective brace 40.

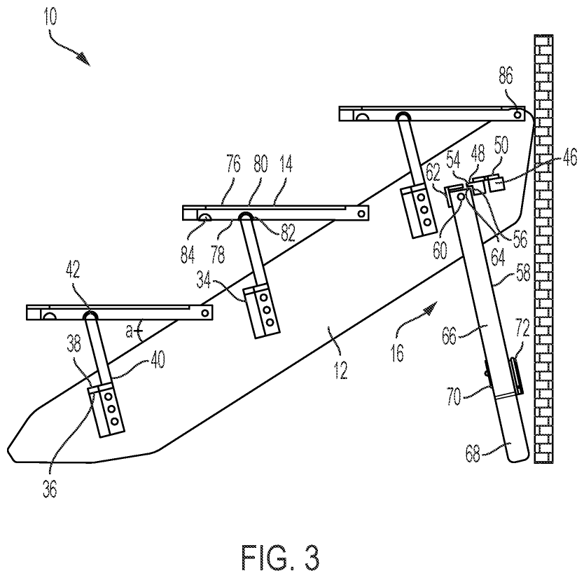

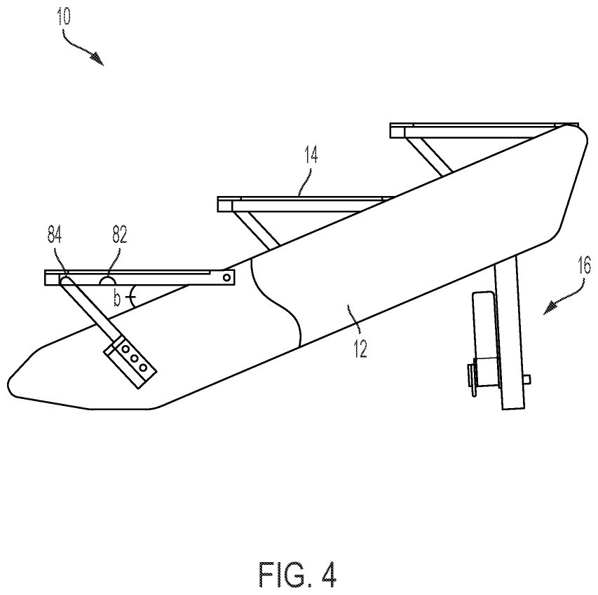

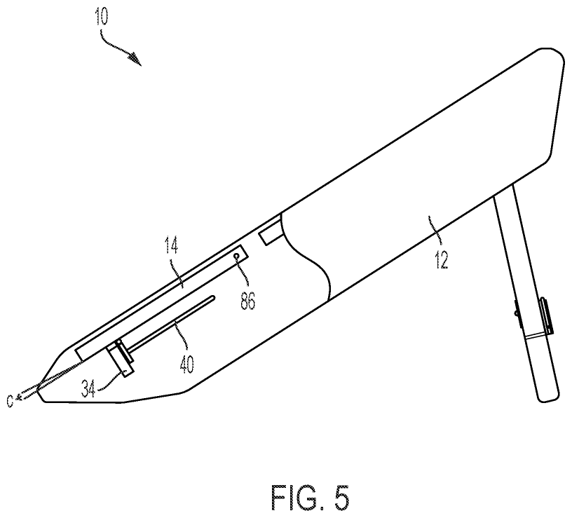

Each tread 14 is pivotally coupled to the inboard surface 24 of the risers 12 through a pivot pin 86 extending into both the tread 14 and the riser 12. The treads 14 are pivotal between a first, high step or stepped position, shown in FIGS. 1 and 3, a second, low step or stepped position, shown in FIG. 4, and a third, ramp position, shown in FIGS. 2, 5 and 6. With the treads 14 in their high stepped position, the pivot brace 40 is pivoted to a position wherein the brace top edge 42 is received within the first groove 82. This sets the treads 14 at a first step angle (angle a) relative to the risers 12. With the treads 14 in their low stepped position, the pivot brace 40 is pivoted to a position wherein the brace top edge 42 is received within the second groove 82. This sets the treads 14 at a second step angle (angle b) relative to the risers 12 that is smaller than the first step angle (angle a). With the treads 14 in their ramp position, the pivot brace 40 is pivoted to a position wherein the brace top edge 42 is pivoted forwardly so that it is not received within either groove and the treads 14 rest upon and are supported by the underlying cross member 34. This sets the treads 14 at a third step angle or ramp angle relative to the risers (angle c which may be zero angle therebetween), which also sets the treads 14 generally coplanar with each other to provide a smooth continuous ramp surface with minimal space between adjacent treads 14.

In use, the stairs 10 is brought to a location adjacent an elevated structure, such as a bed, that the stairs 10 are intended to aid the dog in reaching. A determination is made as to what height the stairs 10 should be set and whether the stairs should be configured as steps or stairs, as shown in FIGS. 1, 3 and 4, or as a ramp, as shown in FIGS. 2, 5 and 6.

Should it be determined that the stairs 10 should be set at its maximum height and as steps, as shown in FIGS. 1 and 3, the lower portion 68 of the main leg portion 58 is pivoted through hinge 70 to its extended position. The latch 72 is then clasped or operated to lock the lower portion 68 in place. The stop block 48 is pivoted through hinge 50 to its locked position wherein the top edge corner 64 of the main leg portion 58 is captured within the stop block notch 52 to lock the position of the main leg portion 58 in place. The treads 14 are then positioned so that the treads are in a generally horizontal configuration. To do so, each brace 40 is pivoted through pivot hinges 38 and the treads 14 are pivoted through pivot pin 86 until the top edge 42 of the brace 40 resides within the first groove 82. Thus, the treads 14 are set in a generally horizontal position associated with the first step angle of the high stepped position of the treads 14 at a first selected height above the supporting surface or floor. This also sets the rise between adjacent steps at a first, maximum spacing.

Should it be determined that the stairs 10 should be set at its minimum height and as steps, as shown in FIG. 4, the lower portion 68 of the main leg portion 58 is pivoted upwardly through hinge 70 to its retracted position. The stop block 48 is pivoted through hinge 50 to its locked position wherein the top edge corner 64 of the main leg portion 58 is captured within the stop block notch 52 to lock the position of the main leg portion 58 in place. The treads 14 are then positioned so that the treads are in a generally horizontal configuration. To do so, each brace 40 is pivoted through pivot hinges 38 and the treads 14 are pivoted through pivot pin 86 until the top edge 42 of the brace 40 resides within the second groove 84. Thus, the treads 14 are again set in a generally horizontal position associated with the second step angle of the low stepped position of the treads 14 at a second selected height above the supporting surface or floor less than the first selected height associated with the high stepped position. This also sets the rise between adjacent steps at a second, minimum spacing that is less than the first spacing for use with smaller dogs.

Should it be determined that the stairs 10 should be set at its maximum height and as a ramp, as shown in FIG. 5, the lower portion 68 of the main leg portion 58 is pivoted through hinge 70 to its extended position. The latch 72 is then clasped or operated to lock the lower portion 68 in place. The stop block 48 is pivoted through hinge 50 to its locked position wherein the top edge corner 64 of the main leg portion 58 is captured within the stop block notch 52 to lock the position of the main leg portion 58 in place. The treads 14 are then positioned so that the tread top surfaces 76 are generally parallel with the riser top surface 26. To do so, each brace 40 is pivoted forwardly through pivot hinges 38 and the treads 14 are pivoted through pivot pin 86 until the treads 14 come to rest upon and are supported by the underlying cross members 34. Thus, the treads 14 are set generally coplanar to each other to provide a generally smooth ramp surface, which may be enhanced by the overlying padding 80. The treads 14 should be sized and shaped so that once the treads are positioned as a ramp, there is minimal space between adjacent treads 14 to prevent the dog's paws from accidentally passing into the space between adjacent treads 14.

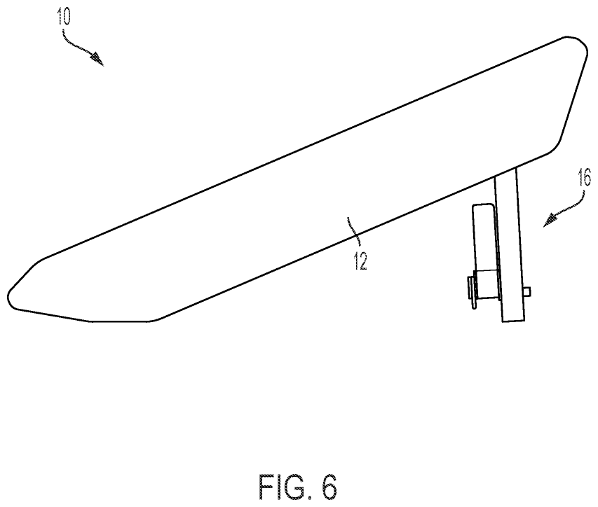

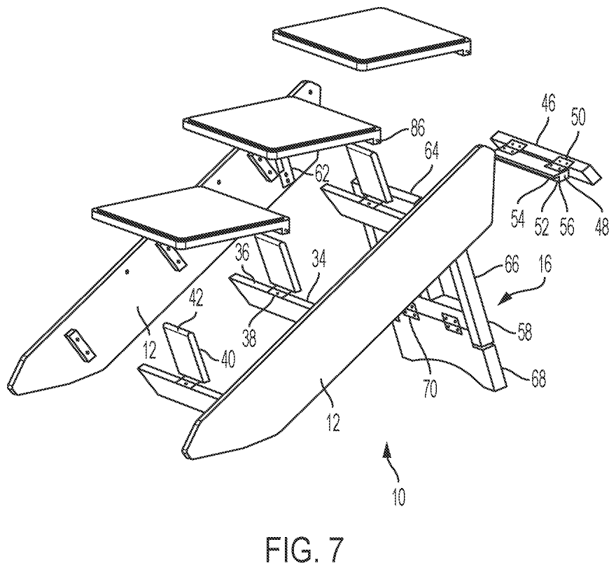

Should it be determined that the stairs 10 should be set at its minimum height and as a ramp, as shown in FIG. 6, the lower portion 68 of the main leg portion 58 is pivoted upwardly through hinge 70 to its retracted position. The stop block 48 is pivoted through hinge 50 to its locked position wherein the top edge corner 64 of the main leg portion 58 is captured within the stop block notch 52 to lock the position of the main leg portion 58 in place. The treads 14 are then positioned so that the treads top surfaces 76 are generally parallel with the riser top surface 26. To do so, each brace 40 is pivoted through pivot hinges 38 and the treads 14 are pivoted through pivot pin 86 until the treads 14 come to rest upon and are supported by the underlying cross members 34. Thus, the treads 14 are set generally coplanar to each other to provide a generally smooth ramp surface, which may be enhanced by the overlying padding 80. The stairs 10 also has the tread ramp surface defined by the treads 14 at a lower selected height than that associated with the extended position of the lower portion 68.

It should be understood that the present stairs 10 may be easily reconfigured to provide stairs of different heights. Also, the stairs 10 may be easily reconfigurable between a set of steps and a smooth ramp. Specifically, the stair ramp is reconfigurable for use as a high stair, a low stair, a high ramp, and a low ramp through the selective positioning or configuration of the support leg and the treads.

Its should be understood that as used herein, the term “ramp” is intended to denote an elongated surface that has an inclined and generally flat or planar walking surface for the pet. Conversely, the term “stairs” is intended to denote an inclined walking surface that is comprised of a staggered series of separate segments or steps that are oriented generally horizontally.

It should be understood that the stop block 48 is used to lock the position of the main leg portion and allow the main leg portion to be unlocked so that it can be pivoted against the cross members 34 to reconfigured the stairs 10 in a compact, stowed configuration for storage or transportation. However, the main leg portion may be fixed to the risers 12 if this feature is not desired.

It should be understood that the treads 14 may be releasably held in place through alternative devices, such as set pins, braces, detents, latches, or the like. Similarly, other types of locking devices may be utilized as an alternative to the stop block 48, again such as set pins, braces, detents, latches, or the like.

It should also be understood that the support leg 16 may be configured to be extended and retracted in other manners, such as through telescoping legs, the addition of threadably adjustable feet, separately attachable extending feet, or the like.

It should be understood that the braces 40 may be joined together for simultaneous pivotal movement of all braces 40.

An adjustable pet stair ramp is described herein comprising under an embodiment a pair of risers, a set of treads pivotally coupled to the pair of risers, the set of treads being moveable between a first step position, a second step position, and a ramp position, and a support leg coupled to the pair of risers, the support leg being adjustable between an extended position setting the treads at a first select height and a retracted position setting the treads at a second select height less than the first select height.

Each the tread of the set of treads has a bottom surface and an oppositely disposed top surface, the bottom surface has a first groove and a second groove; and wherein each the tread of the set of treads includes a pivotal brace coupled to the pair of risers, each the pivot brace being pivotal between a first position wherein a top portion of the brace is received within the first groove, a second position wherein the top portion of the brace is received within the second groove, and a third position wherein the top portion is not received within either the first groove or the second groove, under an embodiment.

The support leg of an embodiment has an upper portion and a lower portion pivotally coupled to the upper portion.

The support leg of an embodiment is pivotally coupled to the risers for movement between an extended position and a retracted position.

The adjustable pet stair ramp of an embodiment comprises a support leg lock to lock the support leg in the extended position.

An adjustable pet stair ramp is described herein comprising under an embodiment a pair of risers, a plurality of treads, each tread being pivotally coupled to the pair of risers for pivotal movement between a first step position set at a first step angle relative to the risers and a second step position set at a second step angle relative to the risers, and a support leg coupled to the plurality of risers, the support leg being adjustable between a first support leg length and a second support leg length less than the first support leg length.

The plurality of treads also has a first ramp angle relative to the risers wherein top surfaces of the treads are coplanar to form a ramp surface, under an embodiment.

Each the tread has a bottom surface and an oppositely disposed top surface, the bottom surface has a first groove and a second groove; and wherein each the tread includes a pivotal brace coupled to the pair of risers, each the brace being pivotal between a first position wherein a top portion of the brace is received within the first groove and a second position wherein the top portion of the brace is received within the second groove, under an embodiment.

Each the brace is also pivotal to a third position wherein the top portion is not received within either the first groove or the second groove, under an embodiment.

The support leg of an embodiment has an upper portion and a lower portion pivotally coupled to the upper portion.

The support leg of an embodiment is pivotally coupled to the risers for movement between an extended position and a retracted position.

The adjustable pet stair ramp of an embodiment comprises a support leg lock to lock the support leg in the extended position.

An adjustable pet stair ramp is described herein comprising under an embodiment a pair of risers, a plurality of treads, each tread being pivotally coupled to the pair of risers for pivotal movement between a first step position set at a first step angle relative to the risers to form a set of stairs and a first ramp angle relative to the risers to form a ramp, and a support leg coupled to the plurality of risers.

The support leg of an embodiment is adjustable between a first support leg length and a second support leg length less than the first support leg length.

Each tread also has a second step position set at a second step angle relative to the risers, under an embodiment.

Each the tread has a bottom surface and an oppositely disposed top surface, the bottom surface has a first groove and a second groove; and wherein each the tread includes a pivotal brace coupled to the pair of risers, each the brace being pivotal between a first position wherein a top portion of the brace is received within the first groove and a second position wherein the top portion of the brace is received within the second groove, under an embodiment.

Each brace is also pivotal to a third position wherein the top portion is not received within either the first groove or the second groove, under an embodiment.

The support leg of an embodiment has an upper portion and a lower portion pivotally coupled to the upper portion.

The support leg of an embodiment is pivotally coupled to the risers for movement between an extended position and a retracted position.

The adjustable pet stair ramp of an embodiment comprises a support leg lock to lock the support leg in the extended position.

It will be appreciated that the embodiments described herein are susceptible to modification, variation and change without departing from the spirit thereof.

1. An adjustable pet stair ramp comprising:
a pair of risers;
a set of treads pivotally coupled to the pair of risers, the set of treads being moveable between a first step position, a second step position, and a ramp position, and
a support leg coupled to the pair of risers, the support leg being adjustable between an extended position setting the treads at a first select height and a retracted position setting the treads at a second select height less than the first select height.

2. The adjustable pet stair ramp of claim 1 wherein each the tread of the set of treads has a bottom surface and an oppositely disposed top surface, the bottom surface has a first groove and a second groove; and wherein each the tread of the set of treads includes a pivotal brace coupled to the pair of risers, each the pivot brace being pivotal between a first position wherein a top portion of the brace is received within the first groove, a second position wherein the top portion of the brace is received within the second groove, and a third position wherein the top portion is not received within either the first groove or the second groove.

3. The adjustable pet stair ramp of claim 1 wherein the support leg has an upper portion and a lower portion pivotally coupled to the upper portion.

4. The adjustable pet stair ramp of claim 1 wherein the support leg is pivotally coupled to the risers for movement between an extended position and a retracted position.

5. The adjustable pet stair ramp of claim 4 further comprising a support leg lock to lock the support leg in the extended position.

6. An adjustable pet stair ramp comprising:
a pair of risers;
a plurality of treads, each tread being pivotally coupled to the pair of risers for pivotal movement between a first step position set at a first step angle relative to the risers and a second step position set at a second step angle relative to the risers, and
a support leg coupled to the plurality of risers, the support leg being adjustable between a first support leg length and a second support leg length less than the first support leg length.

7. The adjustable pet stair ramp of claim 6 wherein the plurality of treads also has a first ramp angle relative to the risers wherein top surfaces of the treads are coplanar to form a ramp surface.

8. The adjustable pet stair ramp of claim 6 wherein each the tread has a bottom surface and an oppositely disposed top surface, the bottom surface has a first groove and a second groove; and wherein each the tread includes a pivotal brace coupled to the pair of risers, each the brace being pivotal between a first position wherein a top portion of the brace is received within the first groove and a second position wherein the top portion of the brace is received within the second groove.

9. The adjustable pet stair ramp of claim 8 wherein each the brace is also pivotal to a third position wherein the top portion is not received within either the first groove or the second groove.

10. The adjustable pet stair ramp of claim 6 wherein the support leg has an upper portion and a lower portion pivotally coupled to the upper portion.

11. The adjustable pet stair ramp of claim 6 wherein the support leg is pivotally coupled to the risers for movement between an extended position and a retracted position.

12. The adjustable pet stair ramp of claim 11 further comprising a support leg lock to lock the support leg in the extended position.

13. An adjustable pet stair ramp comprising:
a pair of risers;
a plurality of treads, each tread being pivotally coupled to the pair of risers for pivotal movement between a first step position set at a first step angle relative to the risers to form a set of stairs and a first ramp angle relative to the risers to form a ramp, and
a support leg coupled to the plurality of risers.

14. The adjustable pet stair ramp of claim 13 wherein the support leg being adjustable between a first support leg length and a second support leg length less than the first support leg length.

15. The adjustable pet stair ramp of claim 14 wherein each tread also has a second step position set at a second step angle relative to the risers.

16. The adjustable pet stair ramp of claim 13 wherein each the tread has a bottom surface and an oppositely disposed top surface, the bottom surface has a first groove and a second groove; and wherein each the tread includes a pivotal brace coupled to the pair of risers, each the brace being pivotal between a first position wherein a top portion of the brace is received within the first groove and a second position wherein the top portion of the brace is received within the second groove.

17. The adjustable pet stair ramp of claim 16 wherein each the brace is also pivotal to a third position wherein the top portion is not received within either the first groove or the second groove.

18. The adjustable pet stair ramp of claim 14 wherein the support leg has an upper portion and a lower portion pivotally coupled to the upper portion.

19. The adjustable pet stair ramp of claim 13 wherein the support leg is pivotally coupled to the risers for movement between an extended position and a retracted position.

20. The adjustable pet stair ramp of claim 19 further comprising a support leg lock to lock the support leg in the extended position.
